(19) United States
(12) Patent Application Publication
(10) Pub. No.: US 2013/0346203 A1
(43) Pub. Date: Dec. 26, 2013

(54) Mobile software allowing retail establishments to sell via a third party application

(71) Applicant: ABBAS BEN AFSHARI, Lexington, KY (US)

(72) Inventor: ABBAS BEN AFSHARI, Lexington, KY (US)

(21) Appl. No.: 13/532,776

(22) Filed: Jun. 25, 2012

(51) Int. Cl. G06Q 30/06

(52) U.S. Cl. CPC G06Q 30/0641
USPC 705/14.55; 705/26.41

(57) ABSTRACT

A Method of consumer shopping where the consumer could use a Mobile device that is equipped with pin locator where the merchants could sell their goods or services thru a direct communication to a buyer of their goods and services using the capabilities of an additional software or hardware or both added to their mobile device.

### REFERENCES CITED

### Referenced by

U.S. Patent Documents

| | | |
|---|---|---|
| 3,573,747 | April 1971 | Adams |
| 3,691,527 | September 1972 | Yamamoto |
| 4,237,537 | December 1980 | Pitches et al. |
| 4,247,759 | January 1981 | Yuris |
| 4,341,951 | July 1982 | Benton |
| 4,449,186 | May 1984 | Kelly et al. |
| 4,553,222 | November 1985 | Kurland et al. |
| 4,554,446 | November 1985 | Murphy et al. |
| 4,677,552 | June 1987 | Sibley, Jr. |
| 4,734,858 | March 1988 | Schlafly |
| 4,737,910 | April 1988 | Kimbrow |
| 4,751,728 | June 1988 | Treat |
| 4,766,548 | August 1988 | Cedrone et al. |
| 4,789,928 | December 1988 | Fujisaki |
| 4,799,156 | January 1989 | Shavit et al. |
| 4,862,357 | August 1989 | Ahlstrom et al. |
| 4,882,675 | November 1989 | Nichtberger et al. |
| 4,903,201 | February 1990 | Wagner |
| 4,931,932 | June 1990 | Dalnekoff et al. |
| 4,947,028 | August 1990 | Gorog |
| 4,992,940 | February 1991 | Dworkin |
| 5,010,485 | April 1991 | Bigari |
| 5,021,953 | June 1991 | Webber et al. |
| 5,064,999 | November 1991 | Okamoto et al. |
| 5,101,353 | March 1992 | Lupien et al. |
| 5,117,354 | May 1992 | Long et al. |
| 5,136,501 | August 1992 | Silverman et al. |
| 5,168,446 | December 1992 | Wiseman |
| 5,176,224 | January 1993 | Spector |
| 5,191,410 | March 1993 | McCalley et al. |
| 5,191,523 | March 1993 | Whitesage |
| 5,191,613 | March 1993 | Graziano et al. |
| 5,224,034 | June 1993 | Katz et al. |
| 5,243,515 | September 1993 | Lee |
| 5,253,165 | October 1993 | Leiseca et al. |
| 5,256,863 | October 1993 | Ferguson et al. |
| 5,262,941 | November 1993 | Saladin et al. |
| 5,283,731 | February 1994 | Lalonde et al. |
| 5,297,031 | March 1994 | Gutterman et al. |
| 5,305,195 | April 1994 | Murphy |
| 5,319,542 | June 1994 | King et al. |
| 5,329,589 | July 1994 | Fraser et al. |
| 5,353,218 | October 1994 | De Lapa et al. |
| 5,361,199 | November 1994 | Shoquist et al. |
| 5,367,452 | November 1994 | Gallery et al. |
| 5,375,055 | December 1994 | Togher et al. |
| 5,404,291 | April 1995 | Kerr et al. |
| 5,420,914 | May 1995 | Blumhardt |
| 5,426,281 | June 1995 | Abecassis |
| 5,434,394 | July 1995 | Roach et al. |
| 5,444,630 | August 1995 | Dlugos |
| 5,452,344 | September 1995 | Larson |
| 5,467,269 | November 1995 | Flaten |
| 5,495,412 | February 1996 | Thiessen |
| 5,500,793 | March 1996 | Deming, Jr. et al. |
| 5,513,117 | April 1996 | Small |
| 5,515,268 | May 1996 | Yoda |
| 5,517,555 | May 1996 | Amadon et al. |
| 5,519,769 | May 1996 | Weinberger et al. |
| 5,526,257 | June 1996 | Lerner |
| 5,537,314 | July 1996 | Kanter |
| 5,546,316 | August 1996 | Buckley et al. |
| 5,550,746 | August 1996 | Jacobs |
| 5,553,131 | September 1996 | Minervino, Jr. et al. |
| 5,557,088 | September 1996 | Shimizu et al. |
| 5,557,517 | September 1996 | Daughterty, III |
| 5,557,518 | September 1996 | Rosen |
| 5,557,721 | September 1996 | Fite et al. |
| 5,561,282 | October 1996 | Price et al. |
| 5,570,283 | October 1996 | Shoolery et al. |
| 5,590,197 | December 1996 | Chen et al. |
| 5,592,378 | January 1997 | Cameron et al. |
| 5,598,375 | January 1997 | Salmon et al. |
| 5,606,602 | February 1997 | Johnson et al. |
| 5,611,051 | March 1997 | Pirelli |
| 5,611,052 | March 1997 | Dykstra et al. |
| 5,612,527 | March 1997 | Ovadia |
| 5,615,269 | March 1997 | Micali |
| 5,631,724 | May 1997 | Sawada et al. |
| 5,637,859 | June 1997 | Menoud |
| 5,640,390 | June 1997 | Sakamoto et al. |
| 5,664,115 | September 1997 | Fraser |
| 5,689,652 | November 1997 | Lupien et al. |
| 5,692,132 | November 1997 | Hogan |
| 5,694,551 | December 1997 | Doyle et al. |
| 5,696,965 | December 1997 | Dedrick |
| 5,701,252 | December 1997 | Facchin et al. |
| 5,708,782 | January 1998 | Larson et al. |
| 5,710,886 | January 1998 | Christensen et al. |
| 5,710,887 | January 1998 | Chelliah et al. |
| 5,713,795 | February 1998 | Kohorn |
| 5,717,989 | February 1998 | Tozzoli et al. |
| 5,727,163 | March 1998 | Bezos |
| 5,727,164 | March 1998 | Kaye et al. |
| 5,732,400 | March 1998 | Mandler et al. |
| 5,734,150 | March 1998 | Brown et al. |
| 5,739,512 | April 1998 | Tognazzini |
| 5,745,882 | April 1998 | Bixler et al. |
| 5,754,653 | May 1998 | Canfield |
| 5,757,917 | May 1998 | Rose et al. |
| 5,758,328 | May 1998 | Giovannoli |
| 5,761,648 | June 1998 | Golden et al. |
| 5,768,142 | June 1998 | Jacobs |
| 5,774,870 | June 1998 | Storey |
| 5,774,874 | June 1998 | Veeneman et al. |
| 5,791,991 | August 1998 | Small |
| 5,794,207 | August 1998 | Walker et al. |
| 5,794,219 | August 1998 | Brown |
| 5,797,127 | August 1998 | Walker et al. |
| 5,799,284 | August 1998 | Bourquin |
| 5,799,285 | August 1998 | Klingman |
| 5,806,044 | September 1998 | Powell |
| 5,809,144 | September 1998 | Sirbu et al. |
| 5,816,918 | October 1998 | Kelly et al. |
| 5,822,736 | October 1998 | Hartman et al. |
| 5,822,737 | October 1998 | Ogram |
| 5,826,244 | October 1998 | Huberman |
| 5,832,452 | November 1998 | Schneider et al. |
| 5,832,457 | November 1998 | O'Brien et al. |
| 5,835,896 | November 1998 | Fisher et al. |
| 5,842,178 | November 1998 | Giovannoli |
| 5,845,259 | December 1998 | West et al. |
| 5,845,265 | December 1998 | Woolston |
| 5,848,399 | December 1998 | Burke |
| 5,855,007 | December 1998 | Jovicic et al. |
| 5,857,175 | January 1999 | Day et al. |
| 5,864,604 | January 1999 | Moen et al. |
| 5,870,716 | February 1999 | Sugiyama et al. |
| 5,870,717 | February 1999 | Wiecha |
| 5,870,719 | February 1999 | Maritzen et al. |
| 5,875,110 | February 1999 | Jacobs |
| 5,878,139 | March 1999 | Rosen |
| 5,878,401 | March 1999 | Joseph |
| 5,883,810 | March 1999 | Franklin et al. |
| 5,887,271 | March 1999 | Powell |
| 5,890,136 | March 1999 | Kipp |
| 5,907,830 | May 1999 | Engel et al. |
| 5,918,213 | June 1999 | Bernard et al. |
| 5,923,016 | July 1999 | Fredregill et al. |
| 5,924,078 | July 1999 | Naftzger |
| 5,924,080 | July 1999 | Johnson |
| 5,924,082 | July 1999 | Silverman et al. |
| 5,938,721 | August 1999 | Dussell et al. |
| 5,963,939 | October 1999 | McCann et al. |
| 5,970,469 | October 1999 | Scroggie et al. |
| 5,988,346 | November 1999 | Tedesco et al. |
| 6,014,634 | January 2000 | Scroggie et al. |
| 6,017,157 | January 2000 | Garfinkle et al. |
| 6,035,284 | March 2000 | Straub et al. |
| 6,038,551 | March 2000 | Barlow et al. |
| 6,055,514 | April 2000 | Wren |
| 6,058,373 | May 2000 | Blinn et al. |
| 6,058,375 | May 2000 | Park |
| 6,061,660 | May 2000 | Eggleston et al. |
| 6,073,840 | June 2000 | Marion |
| 6,085,168 | July 2000 | Mori et al. |
| 6,119,099 | September 2000 | Walker et al. |
| 6,131,085 | October 2000 | Rossides |
| 6,134,534 | October 2000 | Walker et al. |
| 6,167,382 | December 2000 | Sparks et al. |
| 6,192,349 | February 2001 | Husemann et al. |
| 6,193,154 | February 2001 | Phillips et al. |
| 6,193,155 | February 2001 | Walker et al. |
| 6,199,014 | March 2001 | Walker et al. |
| 6,205,435 | March 2001 | Biffar |
| 6,236,971 | May 2001 | Stefik et al. |
| 6,247,047 | June 2001 | Wolff |
| 6,249,772 | June 2001 | Walker et al. |
| 6,260,024 | July 2001 | Shkedy |
| 6,266,651 | July 2001 | Woolston |
| 6,330,544 | December 2001 | Walker et al. |
| 6,370,513 | April 2002 | Kolawa et al. |
| 6,397,212 | May 2002 | Biffar |
| 6,512,570 | January 2003 | Garfinkle et al. |
| 6,754,636 | June 2004 | Walker et al. |
| 6,839,679 | January 2005 | Lynch |
| 7,133,835 | November 2006 | Fusz et al. |
| 2001/0053989 | December 2001 | Keller et al. |
| 8,135,505 | March 2012 | Vangroff et al. |
| 8,150,439 | April 2012 | Vangroff et al. |
| 8,150,735 | April 2012 | Walker et al. |

Foreign Patent Documents

| | | |
|---|---|---|
| 2070736 | December, 1992 | CA |
| 2217739 | October, 1996 | CA |
| 0 370 146 | May, 1990 | EP |
| 0 512 702 | November, 1992 | EP |
| 779587 | June, 1997 | EP |
| 779587 | June, 1997 | EP |
| 0 817 138 | January, 1998 | EP |
| 2 733 068 | October, 1996 | FR |
| 6035946 | February, 1994 | JP |
| 7078274 | March, 1995 | JP |
| 7272012 | October, 1995 | JP |
| 8221484 | August, 1996 | JP |
| 9097288 | April, 1997 | JP |
| 10187820 | July, 1998 | JP |
| 10214284 | August, 1998 | JP |
| 10240830 | September, 1998 | JP |
| 10269049 | October, 1998 | JP |
| 11088560 | March, 1999 | JP |
| WO 95/16971 | June, 1995 | WO |
| WO 96/13013 | May, 1996 | WO |
| WO 96/32701 | October, 1996 | WO |
| WO 96/34356 | October, 1996 | WO |
| WO 97/16797 | May, 1997 | WO |
| WO 97/16897 | May, 1997 | WO |
| WO 97/21200 | June, 1997 | WO |
| WO 97/21200 | June, 1997 | WO |
| WO 97/23838 | July, 1997 | WO |
| WO 97/25684 | July, 1997 | WO |
| WO 97/35441 | September, 1997 | WO |
| WO 97/44749 | November, 1997 | WO |
| WO 97/46961 | December, 1997 | WO |
| WO 98/10361 | March, 1998 | WO |
| WO 98/15907 | April, 1998 | WO |
| WO 98/19260 | May, 1998 | WO |
| WO 98/21713 | May, 1998 | WO |
| WO 98/48388 | October, 1998 | WO |
| WO 98/48563 | October, 1998 | WO |
| WO 98/49658 | November, 1998 | WO |
| WO 99/04326 | January, 1999 | WO |
| WO 99/07121 | February, 1999 | WO |
| WO 99/09508 | February, 1999 | WO |

### FIELD OF THE INVENTION

The present invention is a method of purchasing where a person is looking to purchase normally in a local area around him, and is looking for special cost products such as blow out items and or clearance items or better price items of the same manufacturer or supplier.

### BACKGROUND OF THE INVENTION

normally a consumer looking the purchase best cost items has to physically travel to the stores and retail places or make phone calls and ask specials for a given item from the retailer.

Meanwhile sometimes retailers have overstock or old items that are willing to sell for lower price, on line sales are increasing due to convenient and availability therefore more and more people are looking to purchase with more convenience and better cost.

with the advent of mobile communication devices and their capabilities, a buyer could track their selected items cost thru several retailers or simply check the availability an item or even find a deal on a product or service that he wants to take advantage of a special buy thru a retailer. But often the buyer is not aware of immediate availability of goods and the seller has no way to show the buyer what is available in the retail store unless the buyer physically travels to the store and become aware of the items for special cost.

A need therefore exists for the seller to show his inventory of goods and their costs to buyer and the buyer needs to see the items without making a special trip or phone call to the retailer. Often if a buyer becomes aware of a special on a goods or services even if not immediate needs for the item, They will make a purchase for future use. But the buyer need to have a convenient way to shop without using a computer to log on and preferably wireless mobile device that could track his location and provide to him the most convenient retailer to purchase from.

### SUMMARY OF THE INVENTION

to resolve the problem of not being aware and not knowing availability of certain goods at the retailer of services or goods we provide a mobile device application with capability of checking the sellers items for sale directly from the seller, which is signed up by a third party to have an electronic media for posting the sellers items wanting to sell. The buyer accesses the electronic media and if satisfy purchase the item and have the seller to reserve the item for the buyer for pick up.

Although there are several embodiment that could present the invention we will present 4 sample embodiments:

FIG. 1 is one of the possible embodiment of the present invention, a seller posts their goods, a buyer purchases the goods the seller assigns a third party to administrate the transaction and accept the fund. The third party accepts the funds from a buyer and pays a percentage of the funds to the seller, and after the transaction is complete, the buyer meets the seller and receives the goods from a pick up location.

FIG. 2 In another embodiment, after all transactions, the 3^{rd} party pays for local sales and used taxes automatically.

In another embodiment, the seller gets total amount of the transaction and a software available to the seller will automatically sends a percentage of the transaction to a third party.

In another embodiment of the present invention the seller gets total amount of the transaction and, a software available to the seller will automatically sends a percentage of the transaction to a third party and another percentage to the local sales and used tax.

Above features of the current invention make it clear that the invention has a strong merit and is useful as well as novel, makes the economy between buyer an sellers move faster and create wealth for retailers that often have certain inventory that could be sold and become useful for a buyer. Meanwhile make shopping faster and more convenient between the buyers and the sellers.

### BRIEF DESCRIPTION OF THE DRAWINGS

FIG. 1 is a block diagram of one embodiment of present invention.

FIG. 2 is a block diagram of another embodiment of the present invention.

FIG. 3 is a block diagram of another embodiment of the present invention.

FIG. 4 is a block diagram of another embodiment of present invention.

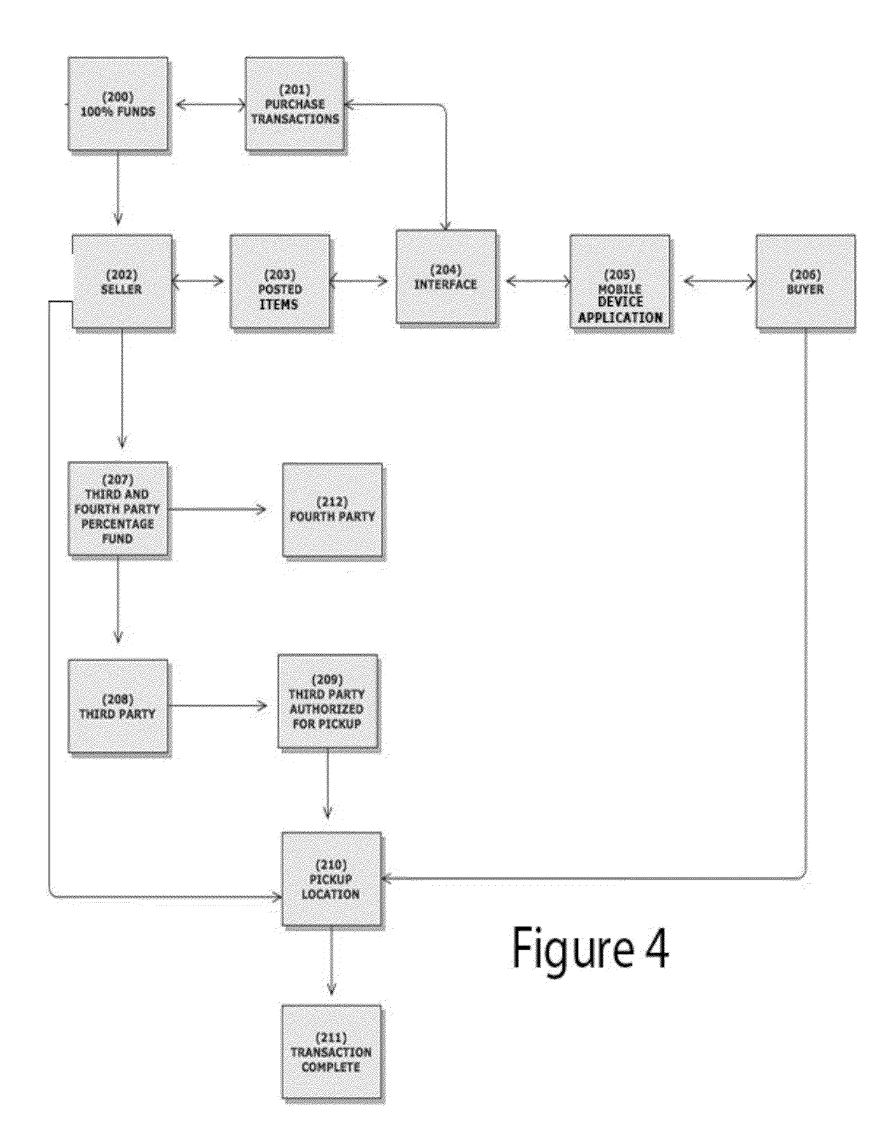

### DETAILED DESCRIPTION OF THE INVENTION

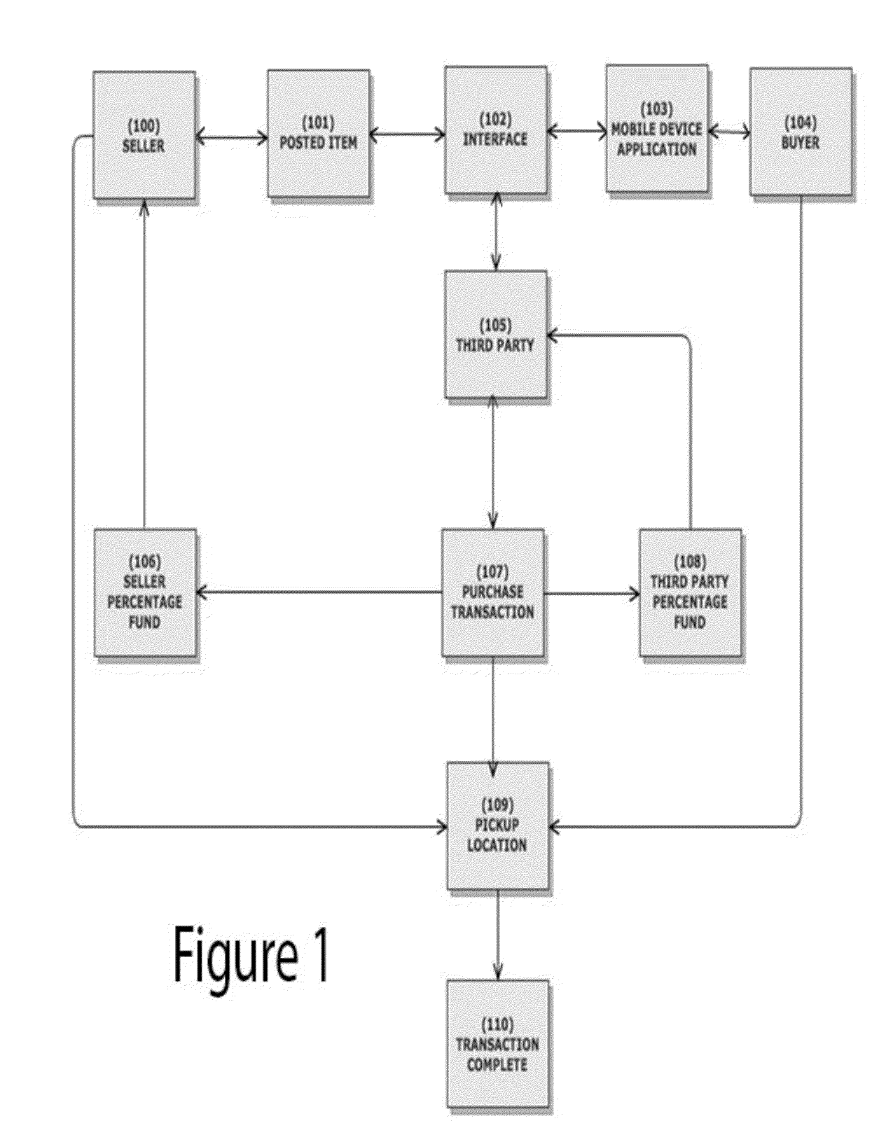

The Block diagram of one embodiment FIG. 1 of present invention represent a seller (100) that has capability of posted items (101) wanting to sell on their electronic media platform which then interfaces with a interface (102) system that inputs this data into third party (105) that makes it visual and transaction able for purchasing. A buyer (104) then views the items using a mobile device application (103) that also interfaces with an interface (102) system that is also inputs data into a third party (105) which makes it transaction able.

The third party (105) facilitates the purchase transaction (107) and divides the fund that is received, then transfers funds to a third party percentage fund (108) and seller percentage fund (106). After the funds transferred, the seller (100) and the buyer (104) get prompt by interface (102) system. The seller (100) goes to a pick up location (109) which is normally at the seller (100) location; the buyer (104) goes to pick up location (109) to receive the items that is purchased by the buyer (104). The Transaction complete (110)

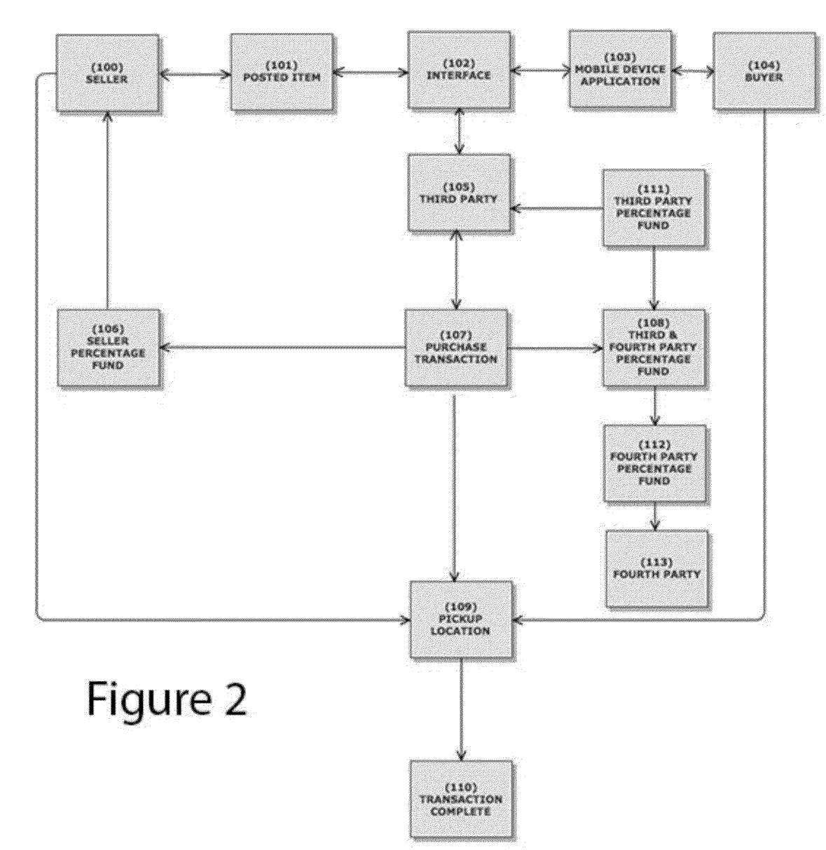

The Block diagram of one embodiment FIG. 2 of present invention represent a seller (100) that has capability of posted items (101) wanting to sell on their electronic media platform which then interfaces with a interface (102) system that inputs this data into third party (105) that makes it visual and transaction able for purchasing. A buyer (104) then views the items using a mobile device application (103) that also interfaces with an interface (102) system that is also inputs data into a third party (105) which makes it transaction able.

The third party (105) facilitates the purchase transaction (107) and divides the funds that is received, then transfers funds to a third party percentage fund (108) and to 4^{th} party percentage fund (111) as well as seller percentage fund (106). After the funds transferred, the seller (100) and the buyer (104) get prompt by interface (102) system. The seller (100) goes to a pick up location (109) which is normally at the seller (100) location; the buyer (104) goes to pick up location (109) to receive the items that is purchased by the buyer (104). The Transaction complete (110)

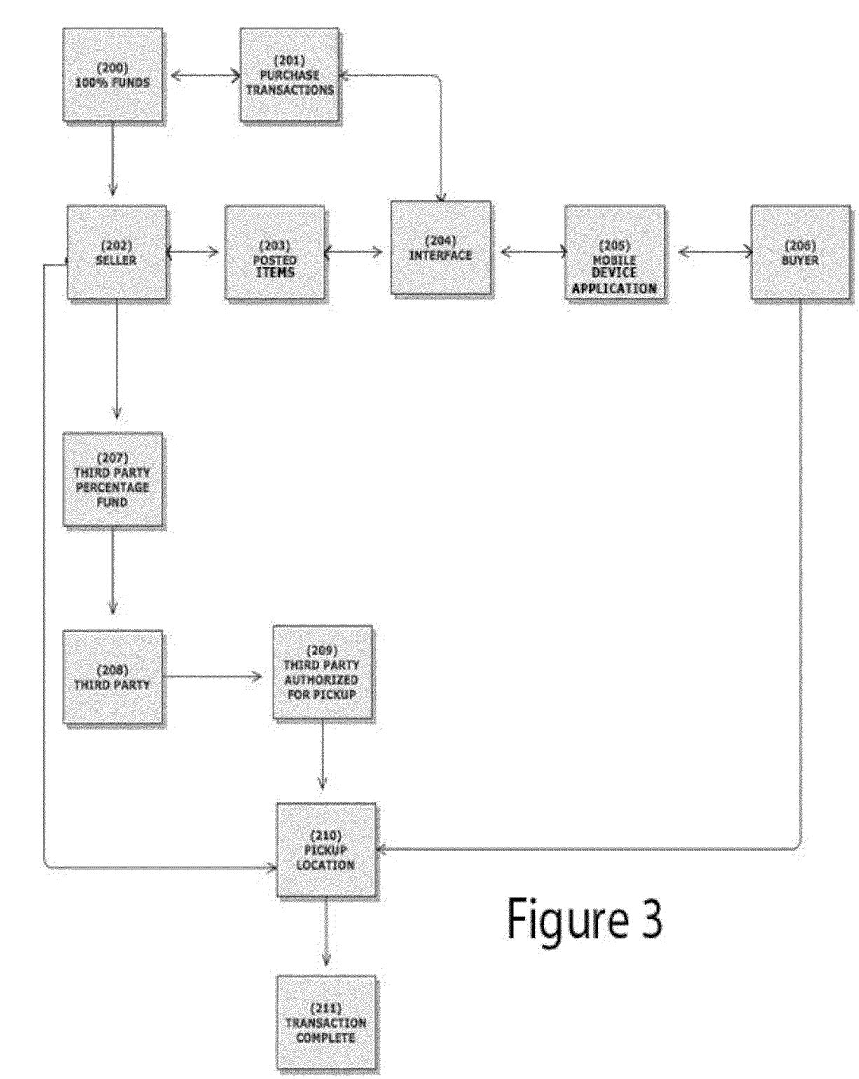

The block diagram form embodiment FIG. 3 of present invention represents a seller (202) being able to get an item posted (203) and interfaces with an interface (204) system that facilitates a purchase transactions (201) the buyer (206) accesses the seller (202) of the posted item (203) thru the mobile device application (205) and purchases the posted item (203) the interface (204) system facilitates the purchase transaction (201) and access 100% of the funds from a buyer (206) thru a mobile device application (205) that interfaces with the interface (204) system. The seller (202) receives 100% funds (200) and facilitates to transfer a third party percentage fund (207) and a third party (208) authorizes thru a third party authorized for pick up (209) then the seller (202) and the buyer (206) go to a pick up location which is preferably the same location as the seller (200) then the transaction completes (211)

The block diagram form embodiment FIG. 3 of present invention represents a seller (202) being able to get an item posted (203) and interfaces with an interface (204) system that facilitates a purchase transactions (201) the buyer (206) accesses the seller (202) of the posted item (203) thru the mobile device application (205) and purchases the posted item (203) the interface (204) system facilitates the purchase transaction (201) and access 100% of the funds from a buyer (206) thru a mobile device application (205) that interfaces with the interface (204) system. The seller (202) receives 100% funds (200) and facilitates to transfer a third party percentage fund (207) and a 4^{th} party (212) and a third party (208) authorizes thru a third party authorized for pick up (209) then the seller (202) and the buyer (206) go to a pick up location which is preferably the same location as the seller (200) then the transaction completes (211)

While the present invention has been described above with respect to 4 embodiments, the scope of the invention is not deemed limited to the above embodiments. Rather, the present invention covers all embodiments falling within the scope and spirit of the following claims as well as equivalent arrangements thereof.

We claim:

1. A method of purchasing, comprising:
A buyer of goods and services having an interest to purchase certain goods and services, and at least one seller of goods and services being a retail establishment, an electronic media posting device controlled by the seller, and an electronic mobile communication device controlled by the buyer equipped with latitude and longitude pin locator capable of accepting an interface application managed by a third party and being subscribe able by the buyer. At least one fund storage account belonging to seller and at least one fund storage account belonging to the buyer and at least one fund storage account belonging to a third party where:
a. The seller has full control over the price of the goods or services that is offered for sale at any time.
b. The seller posts the price of goods and services on the electronic media.
c. The electronic media controlled by the seller is visible thru the application interface enabling the buyer to access the sellers posted price of the goods or services thru the mobile device interface application.
d. The buyer subscribes to the mobile device, application that is the interface between the at least one seller and the buyer.
e. The buyer search for its interest of purchase using the application interface device within selected vicinity by the buyer.
f. The mobile device along with the interface software recognizes the location of the buyer by automatically accessing latitude and longitude pin locator of the mobile device and make visible the at least one seller matching the interest within the buyer selected vicinity.
g. If vicinity is not selected by the buyer then the third party has control over the vicinity and will automatically chooses a vicinity to post all available sellers within the chosen vicinity for the buyer to review.
h. The buyer uses the mobile device application to access the Electronic media controlled by the seller for viewing the sellers posting.
i. The buyer purchases the product or services, using the mobile device application from the mobile device using a credit card or other payment method for the exact same price as is posted on the seller controlled electronic media.
j. The seller allows the funds to be transferred to at least one fund storage account belonging to the third party.
k. A percentage of the funds then transfers from the at least one fund storage account belonging to the third party to the at least one fund storage account belonging to the seller.

2. The application interface of claim 1 is a computer software

3. The application interface of claim 1 is a computer hardware

4. The application interface of claim 1 is a Combination of a computer software and hardware.

5. A method of purchasing, comprising:
A buyer of goods and services having an interest to purchase certain goods and services, and at least one seller of goods and services being a retail establishment, an electronic media posting device controlled by the seller, and an electronic mobile communication device controlled by the buyer equipped with latitude and longitude pin locator capable of accepting an interface application managed by a third party and being subscribe able by the buyer. At least one fund storage account belonging to seller and at least one fund storage account belonging to the buyer and at least one fund storage account belonging to a third party and at least one fund storage account belonging to a 4^{th} party where:
a. The seller has full control over the price of the goods or services that is offered for sale at any time.
b. The seller posts the price of goods and services on the electronic media.
c. The electronic media controlled by the seller is visible thru the application interface enabling the buyer to access the sellers posted price of the goods or services thru the mobile device interface application.
d. The buyer subscribes to the mobile device, application that is the interface between the at least one seller and the buyer.
e. The buyer search for its interest of purchase using the application interface device within selected vicinity by the buyer.
f. The mobile device along with the interface software recognizes the location of the buyer by accessing latitude and longitude pin locator of the mobile device and make visible the at least one seller matching the interest within the buyer selected vicinity.
g. If vicinity is not selected by the buyer then the third party has control over the vicinity and will automatically chooses a vicinity to post all available sellers within the chosen vicinity for the buyer to review.
h. The buyer uses the mobile device application to access the Electronic media controlled by the seller for viewing the sellers posting.
i. The buyer purchases the product or services, using the mobile device application from the mobile device using a credit card or other payment method for the exact same price as is posted on the seller controlled electronic media.
j. The seller allows the funds to be transferred to at least one fund storage account belonging to the third party.
k. A percentage of the funds then transfers from the third party to the at least one fund storage account belonging to the seller.
l. Another percentage to the fund transfers from the third party storage account to 4^{th} party storage account.

6. The fund transferring to the 4^{th} party of claim 5 is equal to the local sales and use taxes assigned by the official government governing the required taxes for this transaction.

7. The application interface of claim 5 is a computer software

8. The application interface of claim 5 is a computer hardware

9. The application interface of claim 5 is a Combination of a computer software and hardware.

10. A method of purchasing, comprising:
A buyer of goods and services having an interest to purchase certain goods and services, and at least one seller of goods and services being a retail establishment, an electronic media posting device controlled by the seller, and an electronic mobile communication device controlled by the buyer equipped with latitude and longitude pin locator capable of accepting an interface application managed by a third party and being subscribe able by the buyer. At least one fund storage account belonging to seller and at least one fund storage account belonging to the buyer and at least one fund storage account belonging to a third party where:
a. The seller has full control over the price of the goods or services that is offered for sale at any time.
b. The seller posts the price of goods and services on the electronic media.
c. The electronic media controlled by the seller is visible thru the application interface enabling the buyer to access the sellers posted price of the goods or services thru the mobile device interface application.
d. The buyer subscribes to the mobile device, application that is the interface between the at least one seller and the buyer.
e. The buyer search for its interest of purchase using the application interface device within selected vicinity by the buyer.
f. The mobile device along with the interface software recognizes the location of the buyer by accessing latitude and longitude pin locator of the mobile device and make visible the at least one seller matching the interest within the buyer selected vicinity.
g. If vicinity is not selected by the buyer then the third party has control over the vicinity and will automatically choose a vicinity to post all available sellers within the chosen vicinity for the buyer to review.
h. The buyer uses the mobile device application to access the Electronic media controlled by the seller for viewing the sellers posting.
i. The buyer purchases the product or services, using the mobile device application from the mobile device using a credit card or other payment method for the exact same price as is posted on the seller controlled electronic media.
j. The funds gets transferred to the fund storage account belonging to the seller
k. A percentage of the funds then transfers to the at least one fund storage account belonging to the third party.
l. The funds gets transferred to the fund storage account belonging to the seller
m. A percentage of the funds then transfers to the at least one fund storage account belonging to the third party.

11. The application interface of claim 10 is a computer software

12. The application interface of claim 10 is a computer hardware

13. The application interface of claim 10 is a Combination of a computer software and hardware.

14. A method of purchasing, comprising:
A buyer of goods and services having an interest to purchase certain goods and services, and at least one seller of goods and services being a retail establishment, an electronic media posting device controlled by the seller, and an electronic mobile communication device controlled by the buyer equipped with latitude and longitude pin locator capable of accepting an interface application managed by a third party and being subscribe able by the buyer. At least one fund storage account belonging to seller and at least one fund storage account belonging to the buyer and at least one fund storage account belonging to a third party and at least one fund storage account belonging to a 4^{th} party where:
a. The seller has full control over the price of the goods or services that is offered for sale at any time.
b. The seller posts the price of goods and services on the electronic media.
c. The electronic media controlled by the seller is visible thru the application interface enabling the buyer to access the sellers posted price of the goods or services thru the mobile device interface application.
d. The buyer subscribes to the mobile device, application that is the interface between the at least one seller and the buyer.
e. The buyer search for its interest of purchase using the application interface device within selected vicinity by the buyer.
f. The mobile device along with the interface software recognizes the location of the buyer by automatically accessing latitude and longitude pin locator of the mobile device and make visible the at least one seller matching the interest within the buyer selected vicinity.
g. If vicinity is not selected by the buyer then the third party has control over the vicinity and will automatically choose a vicinity to post all available sellers within the chosen vicinity for the buyer to review.
h. The buyer uses the mobile device application to access the Electronic media controlled by the seller for viewing the sellers posting.
i. The buyer purchases the product or services, using the mobile device application from the mobile device using a credit card or other payment method for the exact same price as is posted on the seller controlled electronic media.
j. The seller transfers another percentage to the fund storage account belonging to the 4^{th} party.

15. The fund transferring to the 4^{th} party of claim 14 is equal to the local sales and use taxes assigned by the official government governing the required taxes for this transaction.

16. The application interface of claim 14 is a computer software

17. The application interface of claim 14 is a computer hardware

18. The application interface of claim 14 is a Combination of a computer software and hardware.

19. A method of selecting a seller comprising:
A buyer of goods and services having an interest to purchase certain goods and services, and at least one seller of goods and services being a retail establishment, an electronic media posting device controlled by the seller, and an electronic mobile communication device controlled by the buyer equipped with latitude and longitude pin locator capable of accepting an interface application managed by a third party and capable of getting push notification and being subscribe able by the buyer. The buyer capable to select the at least one seller, to get push notification for available goods and services offered by the at least one seller from the said mobile device.
